(19) United States
(12) Patent Application Publication
(10) Pub. No.: US 2012/0134615 A1
(43) Pub. Date: May 31, 2012

(54) HIGH-TEMPERATURE AXLE BEARING MADE OF NI3(SI, TI)-BASED INTERMETALLIC COMPOUND ALLOY AND METHOD FOR PRODUCING THE SAME

(75) Inventors: Takayuki Takasugi, Osaka (JP); Yasuyuki Kaneno, Osaka (JP); Hidekazu Fujii, Osaka (JP)

(73) Assignee: OSAKA PREFECTURE UNIVERSITY PUBLIC CORPORATION, Sakai-shi, Osaka (JP)

(21) Appl. No.: 13/387,689

(22) PCT Filed: Jul. 27, 2010
(86) PCT No.: PCT/JP2010/062640

§ 371 Date: Feb. 14, 2012

(30) Foreign Application Priority Data
Jul. 28, 2009 (JP) 2009-175851

(51) Int. Cl. F16C 33/62; C22F 1/10; C22C 19/05

(52) U.S. Cl. 384/492; 420/451; 148/676; 384/548

(57) ABSTRACT

The present invention provides an axle bearing having excellent life under high temperature.

The present invention provides a high-temperature axle bearing made of an Ni₃(Si, Ti)-based intermetallic compound alloy, wherein the Ni₃(Si, Ti)-based intermetallic compound alloy contains from 25 to 500 ppm by weight of B with respect to a total weight of a composition of 100 at. % containing Ni as a major component, from 7.5 to 12.5 at. % of Si, from 4.5 to 10.5 at. % of Ti, from 0 to 3 at. % of Nb, and from 0 to 3 at. % of Cr, and has a Vickers hardness from 210 to 280 at 800° C.

### TECHNICAL FIELD

The present invention relates to a high-temperature axle bearing, and more particularly to a high-temperature axle bearing made of an intermetallic compound alloy containing Ni₃(Si, Ti) as a basic composition (hereinafter referred to as Ni₃(Si, Ti)-based intermetallic compound alloy”), and a method for producing the same.

### BACKGROUND

Axle bearings are mechanical elements used in many industrial fields, and they are also used in a machine, such as a turbine or an engine, which requires an operation at high temperature. An axle bearing used under high temperature is made of a material such as a martensite stainless steel or a heat-resistant steel for an axle bearing. The upper limit temperature for a satisfactory operation of this type of axle bearing is about 300-400° C. Therefore, research and development for an axle bearing that can operate at high temperature have been made. As an axle bearing having a long life even under a high-temperature special environment, there has been known an axle bearing having rolling elements, wherein a base material of the rolling elements is a bearing steel or stainless steel, and a nitride process is performed on its surface (see, for example, Patent Document 1).

### CITATION LIST

### Patent Document

Patent Document 1: Japanese Unexamined Patent Publication No. 2002-221227

### DISCLOSURE OF THE INVENTION

### Problems to be Solved by the Invention

Recently, axle bearings that can operate even at high temperature are demanded in a manufacturing domain of a semiconductor device or a liquid crystal, or in industrial facilities with heat treatment. Axle bearings having excellent property under high-temperature environment are demanded, and further, axle bearings having excellent life are demanded.

The present invention is accomplished in view of the foregoing circumstance, and aims to provide an axle bearing having excellent life under high temperature.

### Means for Solving the Problems

The present invention provides a high-temperature axle bearing made of an Ni₃(Si, Ti)-based intermetallic compound alloy, wherein the Ni₃(Si, Ti)-based intermetallic compound alloy contains from 25 to 500 ppm by weight of B with respect to a total weight of a composition of 100 at. % containing Ni as a major component, from 7.5 to 12.5 at. % of Si, from 4.5 to 10.5 at. % of Ti, from 0 to 3 at. % of Nb, and from 0 to 3 at. % of Cr, and has a Vickers hardness from 210 to 280 at 800° C.

### EFFECT OF THE INVENTION

Generally, hardness of materials decreases with increasing temperature. With this knowledge, the inventors of the present invention have considered that a material having excellent hardness at room temperature is not always suited as a material for an axle bearing having long life at high temperature, and they have earnestly made studies. As a result, they have found that an axle bearing, which is made of Ni₃(Si, Ti)-based intermetallic compound alloy (hereinafter referred to as “intermetallic compound”) containing from 7.5 to 12.5 at. % of Si, from 4.5 to 10.5 at. % of Ti, from 0 to 3 at. % of Nb, and from 0 to 3 at. % of Cr, has excellent life at high temperatures such as 400° C.-800° C., thus completing the present invention. The axle bearing according to the present invention can well be used at high temperature.

### BRIEF DESCRIPTION OF THE DRAWINGS

FIG. 1 is a sectional view of an axle bearing according to one embodiment of the present invention.

FIG. 2 is a sectional view of an axle bearing according to another embodiment of the present invention.

FIG. 3 shows SEM photographs of an embodiment sample 1 in a demonstration experiment according to the present invention. FIGS. 3(a) and (b), and FIGS. 3(c) and (d) are SEM photographs taken with the same field of view, wherein (a) and (c) are secondary electron images (SEM-SE images), and (b) and (d) are back scattered electron images (SEM-BE images).

FIG. 4 shows SEM photographs of the embodiment sample 1 in the demonstration experiment according to the present invention, wherein (a) is the SEM photograph of an as-cast material to which a homogenization heat-treatment is not performed, and (b) to (d) are the SEM photographs of the sample in which the cast material undergoes the heat treatment.

FIG. 5(a) is an X-ray diffraction profile of the embodiment sample 1 (as-cast material) that does not undergo the homogenization heat-treatment, and (b) is an X-ray diffraction profile of the embodiment sample 1 (homogenization-heat-treated material) that undergoes the homogenization heat-treatment for 48 hours at 1050° C.

FIG. 6 is a graph showing a result of a measurement of Vickers hardness at high temperature in the demonstration experiment of the present invention.

FIG. 7 is a sectional view conceptually showing a thrust rolling life testing machine.

FIG. 8(a) is a top view of a rolling life test piece used for the thrust rolling life testing machine, and (b) is a sectional view of the same.

FIG. 9 shows photographs of an axle bearing according to the embodiment of the present invention, and an inner ring and outer ring of the axle bearing, before a heat-resistant rotation test.

FIG. 10 shows photographs showing the axle bearing and abrasion powders after the heat-resistant rotation test.

FIG. 11 shows photographs of the axle bearing disassembled after the heat-resistant rotation test, wherein (a) to (c) are axle bearings made of SUS440C, and (d) to (f) are axle bearings of embodiment sample 1.

### PREFERRED EMBODIMENTS OF THE INVENTION

### 1. Material of Axle Bearing

A high-temperature axle bearing according to one embodiment of the present invention is made of an Ni₃(Si, Ti)-based intermetallic compound alloy, wherein the Ni₃(Si, Ti)-based intermetallic compound alloy contains from 25 to 500 ppm by weight of B with respect to the total weight of the composition of 100 at. % containing Ni as a major component, from 7.5 to 12.5 at. % of Si, from 4.5 to 10.5 at. % of Ti, from 0 to 3 at. % of Nb, and from 0 to 3 at. % of Cr.

The content of each composition will firstly be described in detail. In the present specification, “from A to B” means that numerical values A and B are included in the range.

The content of Si is from 7.5 to 12.5 at. %, and more preferably from 10.0 to 12.0 at. %. The specific content of Si is, for example, 7.5, 8.0, 8.5, 9.0, 9.5, 10.0, 10.5, 11.0, 11.5, 12.0, or 12.5 at. %. The Si content may take a value between any two values of the aforementioned specific values.

The content of Ti is from 4.5 to 10.5 at. %, and more preferably, from 5.5 to 9.5 at. %. The specific content of Ti is, for example, 4.5, 5.0, 5.5, 6.0, 6.5, 7.0, 7.5, 8.0, 8.5, 9.0 or 9.5 at. %. The Ti content may take a value between any two values of the aforementioned specific values.

Nb and Cr have characteristic of enhancing mechanical property at high temperature. Therefore, either one of Nb and Cr is preferably contained. The content thereof is preferably from 1.5 to 2.5 at. %. Both of Nb and Cr may be contained, and the content thereof may be from 1.5 to 2.5 at. %.

The content of Nb is from 0 to 3 at. %, and more preferably, from 1.5 to 2.5 at. %. The specific content of Nb is, for example, 0, 0.5, 1.0, 1.5, 2.0, 2.5, or 3.0 at. %. The Nb content may take a value between any two values of the aforementioned specific values.

The content of Cr is from 0 to 3 at. %, and more preferably, from 1.5 to 2.5 at. %. The specific content of Cr is, for example, 0, 0.5, 1.0, 1.5, 2.0, 2.5, or 3.0 at. %. The Cr content may take a value between any two values of the aforementioned specific values.

The content of Ni is from 78.5 to 81.0 at. %, and more preferably, from 78.5 to 80.5 at. %. The specific content of Ni is, for example, 78.5, 79.0, 79.5, 80.0, 80.5, or 81.0 at. %. The Ni content may take a value between any two values of the aforementioned specific values.

The content of each element is appropriately adjusted such that the total of the contents of Si, Ti, Nb, Cr, and Ni becomes 100 at. %.

The content of B is from 25 to 500 ppm by weight, more preferably, from 25 to 100 ppm by weight. The specific content of B is, for example, 25, 40, 50, 60, 75, 100, 150, 200, 300, 400, or 500 ppm by weight. The B content may take a value between any two values of the aforementioned specific values.

The specific composition of the intermetallic compound used for the high-temperature axle bearing according to the present embodiment is obtained by adding B in the above-mentioned content to the compositions shown in Tables 1 to 3 (or the compositions within the range between two of the compositions in Tables 1 to 3.)

TABLE 1

| Ni | Si | Ti | Nb | Cr |
|---|---|---|---|---|
| atomic % | atomic % | atomic % | atomic % | atomic % |
| 78.5 | 12.5 | 5.0 | 2.0 | 2.0 |
| 78.5 | 11.0 | 6.5 | 2.0 | 2.0 |
| 78.5 | 9.0 | 8.5 | 2.0 | 2.0 |
| 78.5 | 11.0 | 4.5 | 3.0 | 3.0 |
| 78.5 | 10.0 | 5.5 | 3.0 | 3.0 |
| 78.5 | 7.5 | 8.0 | 3.0 | 3.0 |
| 78.5 | 12.5 | 5.5 | 0.5 | 3.0 |
| 78.5 | 11.0 | 7.0 | 0.5 | 3.0 |
| 78.5 | 9.5 | 8.5 | 0.5 | 3.0 |
| 78.5 | 12.5 | 5.5 | 3.0 | 0.5 |
| 78.5 | 11.0 | 7.0 | 3.0 | 0.5 |
| 78.5 | 9.5 | 8.5 | 3.0 | 0.5 |
| 78.5 | 12.5 | 8.0 | 0.5 | 0.5 |
| 78.5 | 12.0 | 8.5 | 0.5 | 0.5 |
| 78.5 | 12.5 | 6.0 | 3.0 | 0.0 |
| 78.5 | 11.0 | 7.5 | 3.0 | 0.0 |
| 78.5 | 10.0 | 8.5 | 3.0 | 0.0 |
| 78.5 | 12.5 | 8.5 | 0.5 | 0.0 |
| 78.5 | 12.0 | 8.5 | 1.0 | 0.0 |
| 78.5 | 12.5 | 6.0 | 0.0 | 3.0 |
| 78.5 | 11.0 | 7.5 | 0.0 | 3.0 |
| 78.5 | 10.0 | 8.5 | 0.0 | 3.0 |
| 78.5 | 12.5 | 8.5 | 0.0 | 0.5 |
| 78.5 | 11.0 | 10.5 | 0.0 | 0.0 |

TABLE 2

| Ni | Si | Ti | Nb | Cr |
|---|---|---|---|---|
| atomic % | atomic % | atomic % | atomic % | atomic % |
| 79.5 | 11.0 | 5.5 | 2.0 | 2.0 |
| 79.5 | 8.0 | 8.5 | 2.0 | 2.0 |
| 79.5 | 12.5 | 6.0 | 2.0 | 0.0 |
| 79.5 | 11.0 | 7.5 | 2.0 | 0.0 |
| 79.5 | 8.0 | 10.5 | 2.0 | 0.0 |
| 79.5 | 12.5 | 6.0 | 0.0 | 2.0 |
| 79.5 | 11.0 | 7.5 | 0.0 | 2.0 |
| 79.5 | 8.0 | 10.5 | 0.0 | 2.0 |
| 79.5 | 12.5 | 8.0 | 0.0 | 0.0 |
| 79.5 | 11.0 | 9.5 | 0.0 | 0.0 |
| 79.5 | 10.0 | 10.5 | 0.0 | 0.0 |
| 79.5 | 10.0 | 4.5 | 3.0 | 3.0 |
| 79.5 | 9.0 | 5.5 | 3.0 | 3.0 |
| 79.5 | 7.5 | 7.0 | 3.0 | 3.0 |
| 79.5 | 12.5 | 4.5 | 0.5 | 3.0 |
| 79.5 | 10.0 | 7.0 | 0.5 | 3.0 |
| 79.5 | 8.5 | 8.5 | 0.5 | 3.0 |
| 79.5 | 12.5 | 4.5 | 3.0 | 0.5 |
| 79.5 | 10.0 | 7.0 | 3.0 | 0.5 |
| 79.5 | 8.5 | 8.5 | 3.0 | 0.5 |
| 79.5 | 12.5 | 7.0 | 0.5 | 0.5 |
| 79.5 | 11.0 | 8.5 | 0.5 | 0.5 |
| 79.5 | 12.5 | 5.0 | 3.0 | 0.0 |
| 79.5 | 10.0 | 7.5 | 3.0 | 0.0 |
| 79.5 | 9.0 | 8.5 | 3.0 | 0.0 |
| 79.5 | 12.5 | 7.5 | 0.5 | 0.0 |
| 79.5 | 11.0 | 8.5 | 1.0 | 0.0 |
| 79.5 | 12.5 | 5.0 | 0.0 | 3.0 |
| 79.5 | 10.0 | 7.5 | 0.0 | 3.0 |
| 79.5 | 9.0 | 8.5 | 0.0 | 3.0 |
| 79.5 | 12.5 | 7.5 | 0.0 | 0.5 |
| 79.5 | 11.5 | 8.5 | 0.0 | 0.5 |

TABLE 3

| Ni | Si | Ti | Nb | Cr |
|---|---|---|---|---|
| atomic % | atomic % | atomic % | atomic % | atomic % |
| 81.0 | 10.5 | 4.5 | 2.0 | 2.0 |
| 81.0 | 9.0 | 6.0 | 2.0 | 2.0 |
| 81.0 | 7.5 | 7.5 | 2.0 | 2.0 |
| 81.0 | 8.5 | 4.5 | 3.0 | 3.0 |
| 81.0 | 7.5 | 5.5 | 3.0 | 3.0 |
| 81.0 | 11.0 | 4.5 | 0.5 | 3.0 |
| 81.0 | 9.5 | 6.0 | 0.5 | 3.0 |
| 81.0 | 7.5 | 8.0 | 0.5 | 3.0 |
| 81.0 | 11.0 | 4.5 | 3.0 | 0.5 |
| 81.0 | 9.5 | 6.0 | 3.0 | 0.5 |
| 81.0 | 7.5 | 8.0 | 3.0 | 0.5 |
| 81.0 | 12.5 | 5.5 | 0.5 | 0.5 |
| 81.0 | 9.5 | 8.5 | 0.5 | 0.5 |
| 81.0 | 11.5 | 4.5 | 3.0 | 0.0 |
| 81.0 | 9.5 | 6.5 | 3.0 | 0.0 |
| 81.0 | 7.5 | 8.5 | 3.0 | 0.0 |
| 81.0 | 12.5 | 6.0 | 0.5 | 0.0 |
| 81.0 | 9.5 | 8.5 | 1.0 | 0.0 |
| 81.0 | 11.5 | 4.5 | 0.0 | 3.0 |
| 81.0 | 9.5 | 6.5 | 0.0 | 3.0 |
| 81.0 | 7.5 | 8.5 | 0.0 | 3.0 |
| 81.0 | 12.5 | 6.0 | 0.0 | 0.5 |
| 81.0 | 10.0 | 8.5 | 0.0 | 0.5 |

Although the Vickers hardness of Ni₃(Si, Ti)-based intermetallic compound alloy that forms the high-temperature axle bearing according to one embodiment of the present invention is not particularly limited, the Vickers hardness at 800° C. is preferably from 210 to 280. More specifically, it is, for example, 210, 220, 230, 240, 250, 260, 270, or 280. The Vickers hardness at 800° C. may take a value between any two values of the aforementioned specific values.

The Vickers hardness at 600° C. is preferably from 300 to 360. More specifically, it is, for example, 300, 310, 320, 330, 340, 350, or 360. The Vickers hardness at 600° C. may take a value between any two values of the aforementioned specific values.

The Vickers hardness at 500° C. is preferably from 370 to 400. More specifically, it is, for example, 370, 380, 390, or 400. The Vickers hardness at 500° C. may take a value between any two values of the aforementioned specific values. The hardness may take a value between any two values of the aforementioned specific values.

The Vickers hardness at room temperature is preferably from 370 to 400. More specifically, it is, for example, 370, 380, 390, or 400. The Vickers hardness at room temperature may take a value between any two values of the aforementioned specific values. The hardness may take a value between any two values of the aforementioned specific values.

The Vickers hardness of Ni₃(Si, Ti)-based intermetallic compound alloy may only be not less than some value, and an axle bearing may be made of Ni₃(Si, Ti)-based intermetallic compound alloy having Vickers hardness exceeding 280 at 800° C., for example. This is similarly applied to the other temperatures. The Vickers hardness at 600° C. may be larger than 360, and the Vickers hardness at 500° C. may be larger than 400. The Vickers hardness at room temperature may be larger than 400. As described above, the axle bearing may be made of Ni₃(Si, Ti)-based intermetallic compound alloy having Vickers hardness larger than the described numerical values.

The difference between the Vickers hardness at room temperature and the Vickers hardness at 800° C. is not particularly limited, but it is preferably from 50 to 200. Specifically, it is, for example, 50, 100, 150, 190, or 200. This difference may take a value between any two values of the aforementioned specific values.

The microstructure of the Ni₃(Si, Ti)-based intermetallic compound alloy will next be described. The intermetallic compound alloy used for the high-temperature axle bearing according to the present embodiment preferably contains a single-phase microstructure including an L1₂ phase, or a microstructure including an L1₂ phase and a Ni solid solution phase. If a hard secondary phase such as Ni₃Nb is dispersed, the portion where the hard secondary phase is present is easy to be peeled or cracked. Therefore, the intermetallic compound alloy having a single phase of the L1₂ phase or having a phase such as the Ni solid solution phase, which has almost the same hardness as the matrix, may be preferable for forming the axle bearing. The L1₂ phase is Ni₃(Si, Ti) phase into which Nb is solidly dissolved, and the Ni solid solution phase has an fcc structure, wherein a lattice constant thereof is almost equal to that of the L1₂ phase.

From the viewpoint of the Vickers hardness, the single-phase microstructure including the L1₂ phase is preferable. On the other hand, from the viewpoint of productivity and processability of the axle bearing, the microstructure including the L1₂ phase and the Ni solid solution phase is preferable. From the viewpoint of uniformity in the microstructure or in the deformation, the L1₂ phase is more preferable than the Ni solid solution phase. Accordingly, the single-phase microstructure including the L1₂ phase is preferable from the viewpoint of the deformation of the axle bearing and the dimensional accuracy.

### 2. Configuration of Axle Bearing

The axle bearing according to the present invention may be a roll bearing or a slide bearing. The axle bearing is not particularly limited, so long as it is a roll bearing or a slide bearing. It may be a ball bearing, roller bearing, journal bearing, radial bearing, or thrust bearing, for example.

A slide bearing will be taken as one embodiment. The portion (e.g., a sliding surface) supporting an axis of the bearing is made of the Ni₃(Si, Ti)-based intermetallic compound alloy. The portion supporting the axis of the bearing is made of a material that can retain hardness at high temperature. Therefore, the bearing according to the present invention has a configuration difficult to be worn, and hence, it has an excellent life.

A roll bearing will be taken as another embodiment. The bearing according to another embodiment has an inner ring, an outer ring, and rolling elements that roll between the inner ring and the outer ring. The rolling elements are made of a ceramic material, and at least either one (i.e., one or both) of the inner ring and the outer ring is made of the Ni₃(Si, Ti)-based intermetallic compound alloy. In the bearing according to the present embodiment, the inner ring, the outer ring, and the rolling elements are made of a material that can retain hardness at high temperature. Therefore, like the bearing according to the above-mentioned embodiment, the bearing according to the present invention has a configuration difficult to be worn, and hence, it has an excellent life. Specifically, a raceway component such as the inner ring or the outer ring is preferably made of the Ni-based intermetallic compound alloy, and the rolling elements are preferably made of the ceramic material. The raceway component means a raceway ring provided with a raceway surface or raceway groove. In the roll bearing, for example, the inner ring and the outer ring correspond to the raceway component, and in the thrust bearing, a raceway washer corresponds to the raceway component.

For example, silicon nitride is preferable for the ceramic material. The other examples of the ceramic material may include silicon carbide, alumina (aluminum oxide), or zirconia (zirconium oxide). The ceramic material is preferable for the rolling elements, because it has small linear expansion coefficient, and it hardly causes adhesion or damage. When the rolling elements are formed from the ceramic material, the axle bearing having the excellent life can be provided.

### 3. Heat-Resistant Property

The axle bearing according to one embodiment of the present invention can well be used at high temperature. The high-temperature axle bearing indicates an axle bearing used at temperature within the range of 400° C. to 800° C. Specific values of the temperature are, for example, 400° C., 450° C., 500° C., 550° C., 600° C., 650° C., 700° C., 750° C., and 800° C. The temperature may take a value between any two values of the aforementioned specific values.

From the viewpoint of the Vickers hardness, the bearing may preferably be used at 500° C. or higher, and more preferably, used at 600° C. or higher. The axle bearing can more preferably be used at 500° C. or higher, compared to SUS630 (Fe-17Cr-4Ni-4Cu-0.35Nb). The axle bearing can more preferably be used at 600° C. or higher, compared to SUS440 C (Fe-18Cr-1C).

From the viewpoint of the material of the Ni₃(Si, Ti)-based intermetallic compound, the maximum operating temperature is preferably 800° C. or less.

### 4. Method of Producing Axle Bearing

An ingot of the Ni₃(Si, Ti)-based intermetallic compound alloy that forms the axle bearing is produced. For example, raw metals of the respective elements are prepared with the composition in the above-mentioned embodiment. Thereafter, they are melted in a melting furnace, put in a mold, and solidified. With this process, the ingot having the microstructure comprised of the L1₂ phase, or the microstructure comprised of the L1₂ phase and the Ni solid solution phase is prepared. From the viewpoint of strength at high temperature and uniformity in deformation, it is preferable that a heat treatment is further performed to the cast ingot. The heat treatment (homogenization heat-treatment) is performed to remove inhomogeneous solidified microstructure, and the condition thereof is not particularly limited. For example, the ingot may undergo the heat treatment in vacuum from 950 to 1100° C. for 24-48 hours. With this heat treatment, solidification strain due to a solidification rate, or inhomogeneity in a cast structure caused in a large-sized ingot can be overcome. The Ni solid solution phase with fcc structure can be reduced, so that the Vickers hardness can be enhanced. Accordingly, the material for the axle bearing having more excellent life can be provided.

Next, the prepared ingot of the intermetallic compound alloy is processed into a predetermined shape so as to form an axle bearing. For example, the prepared ingot is cut, and the cutting work is carried out, whereby an axle bearing with a predetermined shape is formed. Here, the ingot is cut, and the cutting work is carried out. However, this is only illustrative, and the invention is not limited to the cutting work. For example, a known process, such as a plastic working, can appropriately be used. Alternatively, the ingot may directly be shaped into the inner ring or the outer ring by a method of directly melting and casting the ingot into the shape of the inner ring or the outer ring, or a powder metallurgy process.

Finally, the axle bearing is assembled by using the inner ring, the outer ring, and the rolling elements. The rolling elements may be selected and acquired from those having a size corresponding to a predetermined gap between the inner ring and the outer ring.

The heat treatment may be performed after the formed ingot is cut, and the cutting work is carried out.

The embodiment of the present invention will next be described with reference to the drawings.

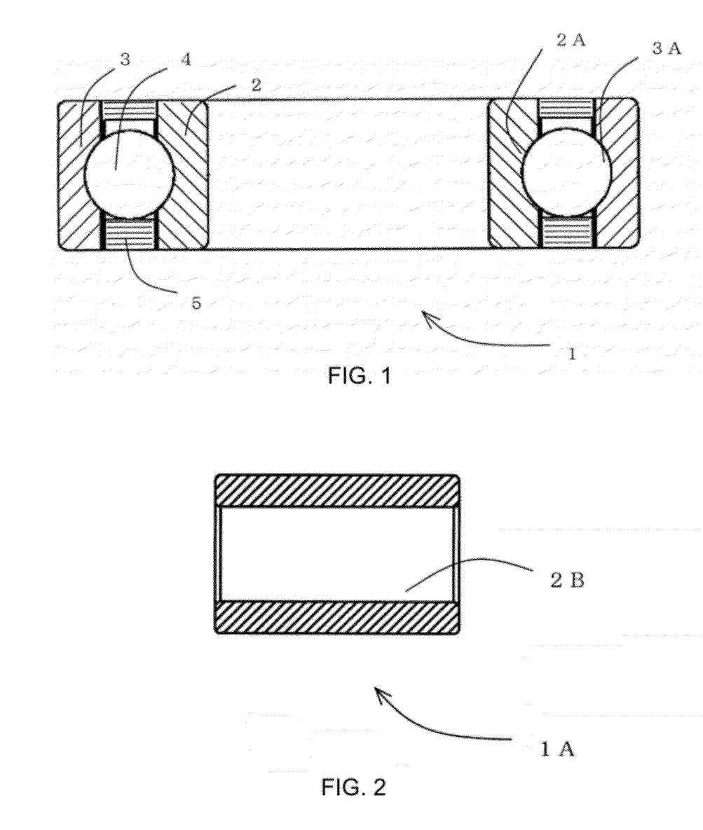

FIG. 1 illustrates a roll bearing (ball bearing) as one example of the embodiment. FIG. 1 is a sectional view of the roll bearing. The roll bearing 1 shown in FIG. 1 includes an inner ring 2 having an inner periphery and an outer periphery, an outer ring 3 that has an inner periphery and an outer periphery, and that is arranged such that the inner periphery faces the outer periphery of the inner ring 2, rolling elements 4 that roll between the outer periphery of the inner ring 2 and the inner periphery of the outer ring 3, and a holder 5 that holds the rolling elements 4 in such a manner that the rolling elements 4 can roll. Raceway surfaces 2A and 3A are respectively formed on the outer periphery of the inner ring 2 and the inner periphery of the outer ring 3, wherein the inner ring 2 and the outer ring 3 are arranged with a predetermined gap in order that the rolling elements 4 roll on the raceway surfaces 2A and 3A. In the roll bearing 1, the inner ring 2 and the outer ring 3 are made of the Ni₃(Si, Ti)-based intermetallic compound alloy, and the rolling elements 4 are made of the ceramic material. As for the inner ring 2 and the outer ring 3, the raceway surfaces 2A and 3A of the inner ring 2 and the outer ring 3 may be made of the Ni₃(Si, Ti)-based intermetallic compound alloy, for example. Alternatively, either one of the inner ring 2 and the outer ring 3, or either one of the raceway surfaces 2A and 3A may be made of Ni-based intermetallic compound alloy.

The holder 5 is preferably made of a material having a lubrication action. For example, graphite, soft metal, ceramic, or a composite of these materials, is preferable.

FIG. 2 shows the slide bearing according to another embodiment. FIG. 2 is a sectional view of the slide bearing. The slide bearing 1A shown in FIG. 2 is a journal bearing having a so-called single-layer structure (solid type). It is formed into a cylindrical shape, and a slide surface 2B is formed on its inner periphery. In the bearing according to this embodiment, the whole bearing including the slide surface 2B is formed from the Ni-based intermetallic compound alloy. The whole bearing may be formed from the Ni-based intermetallic compound alloy. On the other hand, the slide bearing may have a so-called double-layer structure (bimetal type) including an alloy layer that forms an inner periphery and that is formed from the Ni-based intermetallic compound alloy, and a back metal layer formed from stainless on its outer periphery.

Various features shown in the above-mentioned embodiments can be combined to one another. When one embodiment includes plural features, one or plural features are appropriately extracted, and the extracted one feature can solely applied to the present invention, or the extracted plural features can be combined and applied to the present invention.

### 5. Performance Test

A performance test of the present invention will next be described. In the following test, a sample made of the Ni₃(Si, Ti)-based intermetallic compound alloy having the composition shown in the above-mentioned embodiment, and a sample made of SUS440C that is a hard material exhibiting the highest hardness out of stainless steels were employed. For both samples, a mechanical property, a rolling fatigue life test, and a heat-resistant rotation test were carried out to evaluate these samples, in order to verify that the high-temperature axle bearing according to the present invention has excellent property at high temperature.

### A. Manufacture of Sample

A sample made of an intermetallic compound was formed with the process described below.

### (1) Manufacture of Ingot

Raw metals of Ni, Si, Ti, and Nb (each having a purity of 99.9 wt. %) and B were weighed to have the composition shown in Table 4. An ingot with 78φ×280 mm (about 11 kg) was formed as the sample containing Nb by a vacuum induction melting (VIM) process, while an ingot with a thickness of 10 mm was formed as the sample not containing Nb by an arc melting process. A melting chamber for the arc melting process was firstly evacuated, and then, the atmosphere in the melting chamber was replaced with an inert gas (argon gas). Non-consumable tungsten electrodes were used as electrodes of the furnace, and a water-cooling copper hearth was employed as a mold. The homogenization heat-treatment was performed to the sample not containing Nb in order to eliminate cast segregation and to be homogenized. During the homogenization process, a vacuum heat treatment (furnace cool) was performed in which the sample was retained at 1050° C. for 48 hours.

The sample containing Nb is the Ni₃(Si, Ti)-based intermetallic compound alloy that is the material used in the embodiment of the present invention, and it will be referred to as “embodiment sample 1” below. The sample not containing Nb is one example of the Ni₃(Si, Ti)-based intermetallic compound alloy that is the material used for the axle bearing of the present invention, and it will be referred to as “embodiment sample 2” below.

TABLE 4

| | Ni | Si | Ti | Nb | Cr | B |
|---|---|---|---|---|---|---|
| | atomic | atomic | atomic | atomic | atomic | weight |
| | % | % | % | % | % | ppm |
| Embodiment | 79.5 | 11.0 | 7.5 | 2.0 | — | 50 |
| sample 1 | | | | | | |
| Embodiment | 79.5 | 11.0 | 9.5 | — | — | 50 |
| sample 2 | | | | | | |

### (2) Processing of Ball Bearing

The ingot of the embodiment sample 1 was cut into a predetermined thickness. The cutting work was performed to the obtained disk material, whereby an inner ring and an outer ring of the bearing were produced. A rough grinding process was performed to the inner diameter, outer diameter, and end face, and then, a super finishing grinding process that was the final finish was performed to the raceway surfaces of the inner ring and the outer ring.

### (3) Assembly of High-Temperature Ball Bearing

A silicon-nitride-ceramic ball was assembled in order that the produced inner ring and the outer ring were arranged with a predetermined gap. A solid lubricant holder was attached. Thus, the ball bearing shown in FIG. 1 was completed.

### B. Evaluation

### (1) Observation of Structure

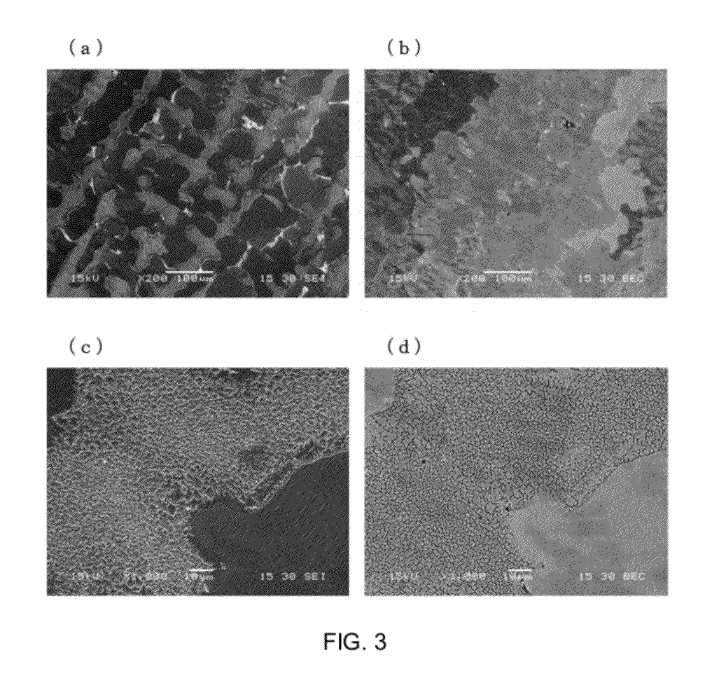

The sectional structure of the ingot of the embodiment sample 1 was evaluated. FIG. 3 shows SEM photographs of the embodiment sample 1. Referring to FIGS. 3(a) and 3(b), it is found that the embodiment sample 1 that is a cast material has a dendritic structure. FIGS. 3(c) and 3(d) are photographs taken at high magnification. It was confirmed from FIGS. 3(c) and 3(d) that a single-phase structure was formed in a dark contrast region, while a rectangle microstructure was formed in a gray contrast region. The dark contrast region is considered to be an Ni₃(Si, Ti) intermetallic compound phase with an L1₂ structure, while the gray contrast region is considered to be the Ni solid solution phase with an fcc structure. It is understood from these figures that the embodiment sample 1 has the microstructure in which the Ni solid solution phase with an fcc structure appears in the L1₂ phase region. It was estimated from the back scattered electron image (BEI) in FIG. 3 that there is little difference in contrasting density between the L1₂ phase and the Ni solid solution phase, and hence, both phases had a similar alloy composition.

In order to eliminate the cast segregation and attain homogenized microstructure, the homogenization heat-treatment was performed to the embodiment sample 1, and then, the microstructure was observed.

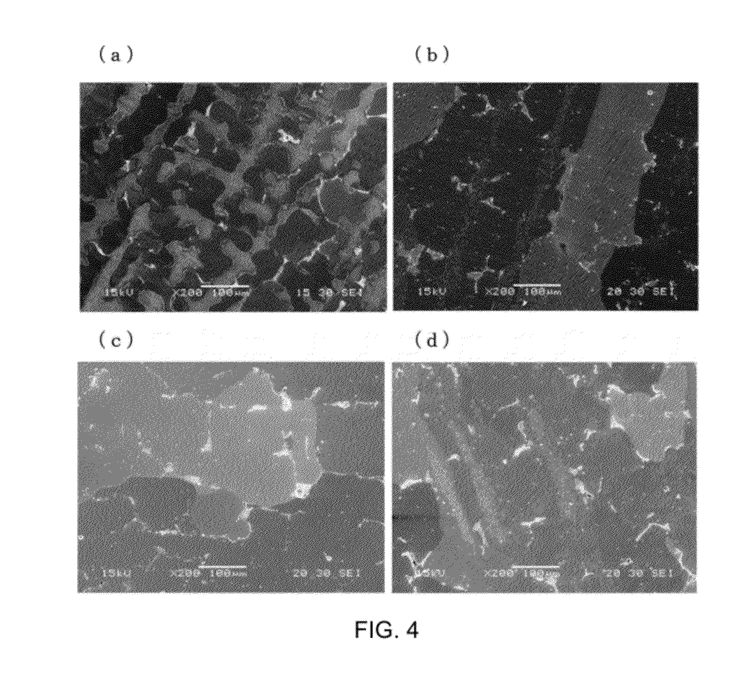

FIG. 4(a) is an SEM photograph of the embodiment sample 1 to which the vacuum heat-treatment (furnace cool) has not been performed. FIG. 4(b) is an SEM photograph of the embodiment sample 1 to which the vacuum heat-treatment for 48 hours at 1050° C. has been performed. It was found from FIGS. 4(a) and 4(b) that, after the homogenization heat-treatment for 48 hours at 1050° C., the dendritic microstructure gradually disappeared, and the Ni solid solution phase also reduced.

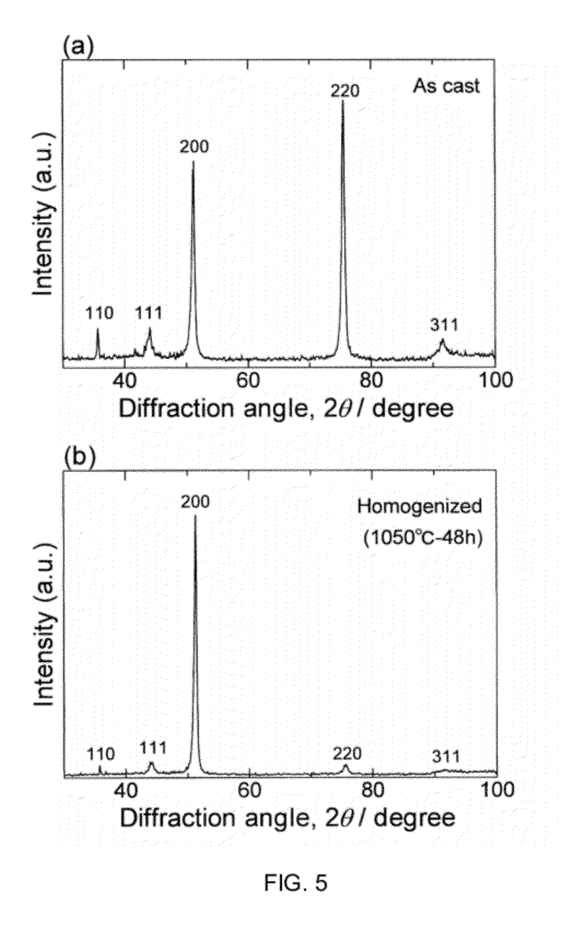

FIG. 5(a) shows the result of the X-ray diffraction (XRD) measurement of the embodiment sample 1 to which the homogenization heat-treatment has not been performed, while FIG. 5(b) shows the result of the X-ray diffraction measurement of the embodiment sample 1 (homogenization-heat-treated material) to which the homogenization heat-treatment for 48 hours at 1050° C. has been performed.

It is found from FIG. 5 that the crystal orientation is changed, but the peak position is not changed, as a result of the homogenization heat-treatment. It is understood from the results of the observation of the structure in FIGS. 3 and 4 that both the embodiment sample 1 (cast material) to which the homogenization heat-treatment has not been performed and the embodiment sample 1 (homogenization-heat-treated material) to which the homogenization heat-treatment has been performed have the structure in which the Ni solid solution phase is dispersed in the L1₂ phase. Since a clear peak separation or peak shift does not appear on the XRD profile in FIG. 5, it is considered that there is little difference in the lattice constant in the L1₂ phase and the Ni solid solution phase.

As is apparent from FIG. 4, the phases other than the L1₂ phase or the Ni solid solution phase are not present.

The inventors have found that the Ni solid solution phase same as that described above appears even in the Ni₃(Si, Ti) alloy containing excessive Ni, and the Ni solid solution phase disappears when the Ni₃(Si, Ti) containing excessive Ni is subjected to a low-temperature heat-treatment. Therefore, the temperature for the heat-treatment was dropped to 950° C. from 1050° C., and then, the change in the microstructure was observed. FIG. 4(c) is a photograph of the embodiment sample 1 that was subjected to the vacuum heat-treatment for 48 hours at 1050° C., and to the vacuum heat-treatment for 48 hours at 950° C. FIG. 4(d) is a photograph of the embodiment sample 1 that was subjected to the vacuum heat-treatment (furnace cool) for 48 hours at 950° C.

It is found from FIGS. 4(c) and 4(d) that the Ni solid solution phase is reduced in both cases. As shown in Table 5, with the decrease of the Ni solid solution phase, the Vickers hardness slightly increases more in the heat-treated material than in the as-cast material.

TABLE 5

| | Vickers |
|---|---|
| | hardness |
| unheat-treatment for homogenization (solidification material) | 387 HV |
| 1050° C.-48 h homogenization heat-treatment | 402 HV |
| 1050° C.-48 h homogenization heat-treatment + | 409 HV |
| 950° C.-48 h heat-treatment | |
| 950° C.-48 h homogenization heat-treatment | 401 HV |

### (2) High-Temperature Vickers Hardness Test

The Vickers hardness test was carried out at high temperature (300° C., 500° C., 600° C., and 800° C.) for the embodiment sample 1, the embodiment sample 2, and the embodiment sample 1 to which the vacuum heat-treatment (furnace cool) for 48 hours at 950° C. was performed. The Vickers hardness test at high temperature was simultaneously carried out for two materials that were SUS440C and SUS630. The SUS440C was subjected to the Vickers hardness test at high temperatures of 300° C., 500° C., and 800° C., while the SUS630 was subjected to the Vickers hardness test at high temperatures of 300° C., 500° C., 600° C., and 800° C. The load was 1 kg, and the retention time was 20 seconds. The measurement was carried out in a reduction atmosphere (Ar+about 10% H₂), and the rate of temperature rise was 10° C. per minute. Prior to the measurement at high temperatures, the Vickers hardness of a test piece, which was the same as that used for the high-temperature Vickers hardness test, at room temperature was measured under the same measurement conditions (load: 1 kg, retention time: 20 seconds).

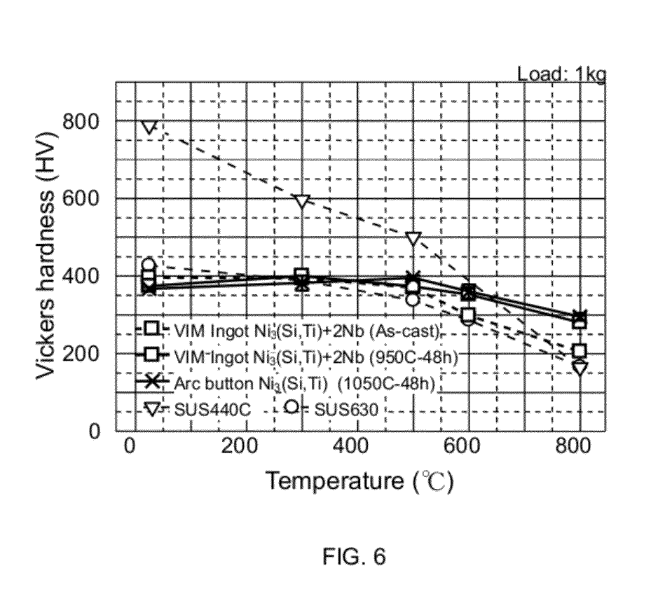

FIG. 6 shows the result of the measurement. FIG. 6 also shows the data of the Vickers hardness of two materials, SUS440C and SUS630. The SUS440C alloy exhibits the highest hardness out of stainless steels, and is used for a ball bearing for a heat-resistant and special environment. In FIG. 6, “VIM ingot Ni₃(Si, Ti)+2 Nb(As-cast)” indicates the ingot of the embodiment sample 1 formed by a vacuum induction process, while “VIM ingot Ni₃(Si, Ti)+2 Nb(950 C-48 h)” indicates the embodiment sample 1 formed by performing the vacuum heat-treatment (furnace cool) to the ingot, formed by the above-mentioned process, for 48 hours at 950° C. “Arc button Ni₃(Si, Ti) (1050 C-48 h)” indicates the embodiment sample 2 formed by performing the vacuum heat-treatment (furnace cool) for 48 hours at 1050° C. to an ingot (hereinafter referred to as an arc button) formed by an arc melting process and having a button shape (thickness: 10 mm).

It is understood from FIG. 6 that the Vickers hardness of a general bearing material such as SUS440C rapidly decreases with the temperature rise, while the Vickers hardness of the embodiment sample 1, the embodiment sample 2, and the embodiment sample 1 to which the vacuum heat-treatment (furnace cool) for 48 hours at 950° C. was performed does not decrease so much.

For example, in FIG. 6, when the temperature changes from room temperature to 800° C., the Vickers hardness of the SUS440C and the Vickers hardness of the SUS630 decrease by about 620 and about 260, respectively. However, the Vickers hardness of the embodiment sample 1, the embodiment sample 2, and the embodiment sample 1 to which the vacuum heat-treatment (furnace cool) for 48 hours at 950° C. was performed only decrease by about 190, about 90, and about 70, respectively.

It is also found that the Vickers hardness of the embodiment sample 1, the embodiment sample 2, and the embodiment sample 1 to which the vacuum heat-treatment (furnace cool) for 48 hours at 950° C. was performed are higher than the Vickers hardness of the SUS630 in the temperature region of 500° C. or more. It is also found that the Vickers hardness of the sample to which the homogenization heat-treatment has been performed is higher than the Vickers hardness of the SUS440C at 600° C. or more.

In light of the environment where the axle bearing is used, it is considered that the alloy such as the SUS440C is deteriorated at high temperature due to oxidation, or the microstructure thereof is changed or becomes coarse. Therefore, when the axle bearing is formed from such material, it can be supposed that the advantages of the embodiment samples appear in the lower temperature region.

It is also found that the Vickers hardness of the embodiment sample 2, and the embodiment sample 1 to which the vacuum heat-treatment (furnace cool) for 48 hours at 950° C. was performed are higher than the Vickers hardness of the embodiment sample 1. This is because the embodiment sample 1 (as-cast material) contains many Ni solid solution phases. From the viewpoint of the hardness at high temperature, the microstructure comprised of only L1₂ single phase is supposed to be desirable.

As can be understood from FIG. 6, the Vickers hardness of the SUS440C was about 790 at room temperature, about 600 at 300° C., about 500 at 500° C., and about 160 at 800° C., and the Vickers hardness of the SUS630 was about 430 at room temperature, about 390 at 300° C., about 340 at 500° C., about 290 at 600° C., and about 170 at 800° C.

On the other hand, the Vickers hardness of the ingot of the embodiment sample 1 formed by the vacuum induction process was about 400 at room temperature, about 390 at 300° C., about 370 at 500° C., about 300 at 600° C., and about 210 at 800° C., and the Vickers hardness of the embodiment sample 1 to which the vacuum heat-treatment (furnace cool) for 48 hours at 950° C. was performed was about 370 at room temperature, about 400 at 300° C., about 370 at 500° C., about 350 at 600° C., and about 280 at 800° C. The Vickers hardness of the embodiment sample 2 was about 370 at room temperature, about 380 at 300° C., about 400 at 500° C., about 360 at 600° C., and about 300 at 800° C.

Tables 6 to 8 show specific values of the Vickers hardness in FIG. 6. Table 6 shows the Vickers hardness of the ingot of the embodiment sample 1 formed by the vacuum induction process at the respective temperatures, while Table 7 shows the Vickers hardness of the embodiment sample 1, to which the vacuum heat-treatment (furnace cool) for 48 hours at 950° C. was performed, at the respective temperatures. Table 8 shows the Vickers hardness of the embodiment sample 2 that was formed by performing the vacuum heat-treatment (furnace cool) to the arc-melted button for 48 hours at 1050° C. The temperature of 25° C. in Tables 6 to 8 corresponds to the room temperature.

TABLE 6

| Temperature/° C. | Hardness HV |
|---|---|
| 25 | 396 |
| 300 | 394 |
| 500 | 370 |
| 600 | 298 |
| 800 | 205 |

TABLE 7

| Temperature/° C. | Hardness HV |
|---|---|
| 25 | 374 |
| 300 | 400 |
| 500 | 373 |
| 600 | 352 |
| 800 | 280 |

TABLE 8

| Temperature/° C. | Hardness HV |
|---|---|
| 25 | 367 |
| 300 | 382 |
| 500 | 395 |
| 600 | 360 |
| 800 | 295 |

### (3) Rolling Fatigue Life Test

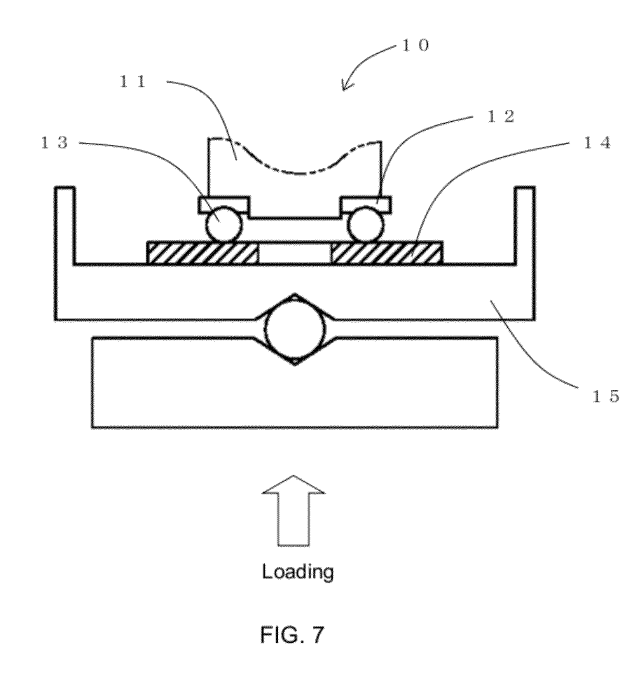

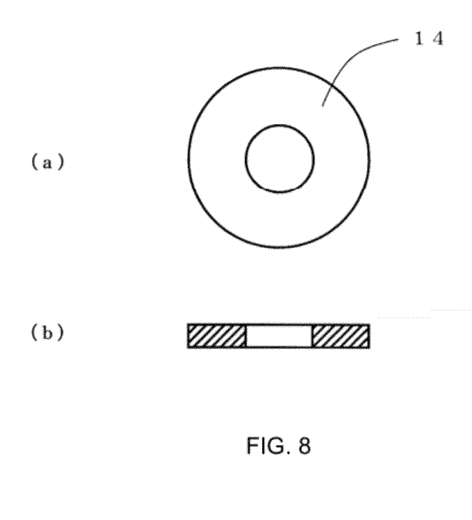

A rolling fatigue life test was carried out for the embodiment sample 1. Specifically, a thrust rolling fatigue life testing machine was used. FIG. 7 is a sectional view conceptually showing the thrust rolling fatigue life testing machine. FIG. 8 shows a top view and a sectional view of a test piece that is the subject to be tested. The thrust rolling life testing machine 10 shown in FIG. 7 applies load from a bearing box 15, and drives a drive shaft 11, thereby rolling a ball 13 on a test piece 14 via an inner ring 12. With this process, the testing machine 10 checks how long the life of the test piece 14 is with what degree of the load.

Firstly, the embodiment sample 1 was processed into a doughnut-shaped disk (outer diameter D of 60 mm×inner diameter d of 20 mm×thickness t of 6 mm) shown in FIG. 8. Then, the test piece 14 was placed onto the bearing box 15 of the thrust rolling life testing machine 10. The test piece 14 was evaluated from the result of the rolling test in which the drive shaft 11 was rotated. Each test was carried out twice.

### Condition for Rolling Fatigue Life Test

The test was carried out by using two types of axle bearings described below.

### 1) Axle Bearing Model Number 51305

Maximum surface pressure (between ball and test piece): 4.4 GPa, 3.3 GPa
Material for load ball: SUJ2
Diameter of load ball: ⅜ inch (9.525 mm)
Raceway diameter of load ball: φ38.5 mm
Rotating speed: 1200 rpm
Lubrication oil: SUPER MULPUS 10 (manufactured by Nippon Oil Corporation)
Lubrication process: In oil
Temperature in test room: 20-25° C.

### 2) Axle Bearing Model Number 51105

Maximum surface pressure (between ball and test piece): 3.2 GPa
Diameter of load ball: ¼ inch (6.35 mm)
Raceway diameter of load ball: φ33.5 mm
Rotating speed: 1200 rpm
Lubrication oil: SUPER MULPUS 10 (manufactured by Nippon Oil Corporation)
Lubrication process: In oil
Temperature in test room: 20-25° C.

Table 9 shows the result of the rolling fatigue life test. Table 9 also shows the result of the rolling fatigue life test of the SUS630 (Fe-17-Cr-4Ni-4Cu-0.35Nb). The column of the “test result” indicates the rolling life of each material under each test condition.

It is found from Table 9 that the rolling life is almost equal to that of the SUS630 under the condition of the load of 250 kgf. The life time was 500 hours or more under the load of 43 kgf, which indicates that the embodiment sample 1 can sufficiently stand use at room temperature.

TABLE 9

| Material of | | | | | | | |
|---|---|---|---|---|---|---|---|
| inner ring | | Axle | Maximum | | | | |
| and | | bearing | surface | | | | |
| outer ring | Load | number | pressure | Test result | | | |
| SUS630 | 250 kgf | 51305 | 4.4 GPa | 12.42 | hr | 41.00 | hr |
| | | | | 4.6 | hr | 14.15 | hr |
| Embodiment | 250 kgf | 51305 | 4.4 GPa | 16.20 | hr | 5.76 | hr |
| sample 1 | 100 kgf | 51305 | 3.3 GPa | 262.31 | hr | 35.15 | hr |
| | 43 kgf | 51105 | 3.2 GPa | 174.63 | hr | 500 | hr |
| | | | | | | | over |

### (4) Heat-Resistant Rotation Test

A heat-resistant rotation test was carried out for a ball bearing (embodiment) using an inner ring and an outer ring formed from the embodiment sample 1. Specifically, the ball bearing was rotated under high-temperature environment, and then, the appearance of the ball bearing was checked, and the size of the ball bearing was measured, whereby the ball bearing was evaluated. The same test was carried out for a ball bearing, which was assembled by an outer ring and an inner ring formed from SUS440C (Fe-18Cr-1C) and had the shape same as that formed from the embodiment sample. This ball bearing was also evaluated.

The condition of the test was as follows:
Temperature: 600° C.
Load: 60 kgf
Rotating speed: 166 rpm
The ball bearing described below was used.
Specification: 6206SO (T02)Y3
Rolling elements: Ceramic ball ⅜ inch (9.525 mm, part number FYN-SN)
Holder: BS10609 UR-06 (manufactured by Kogi Corporation)

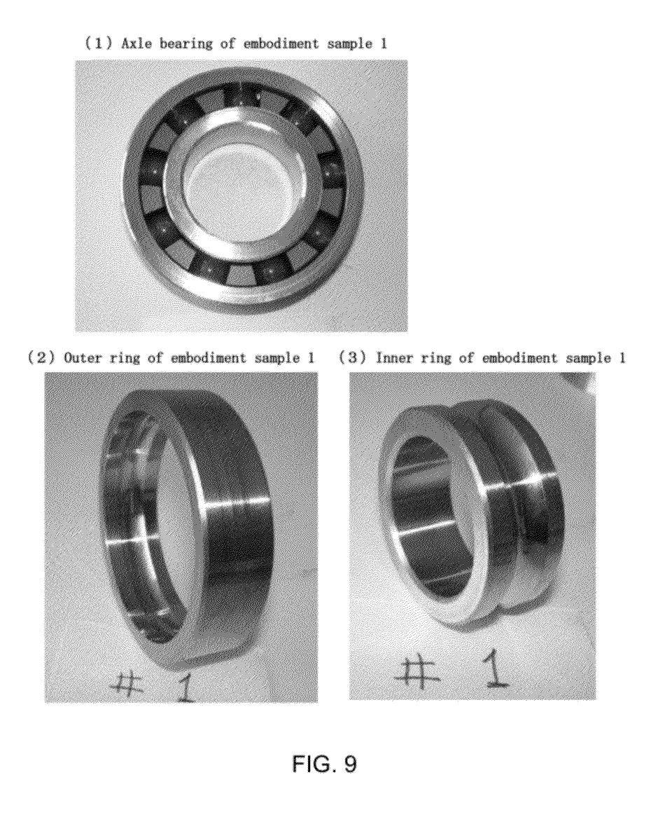

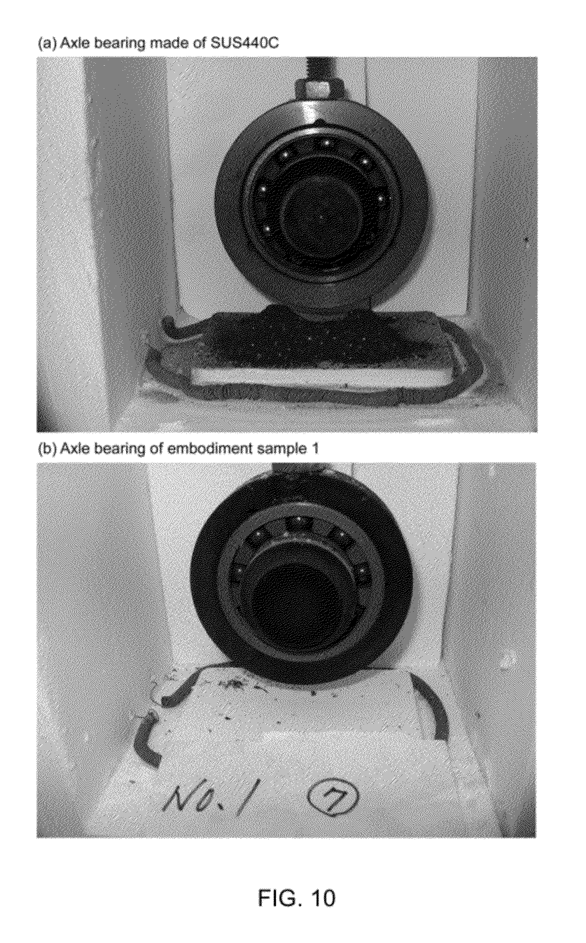

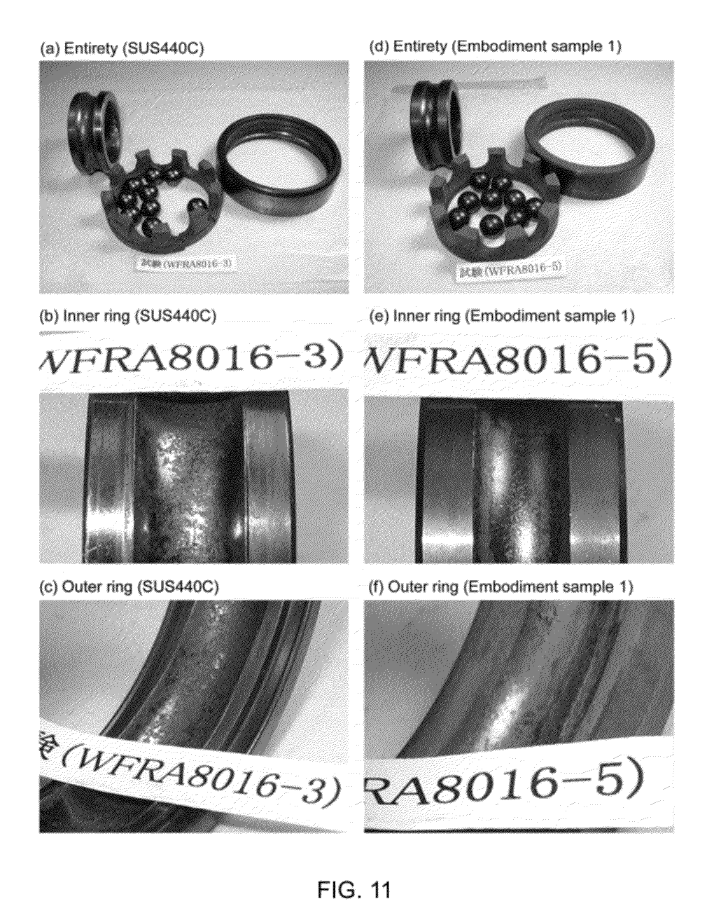

FIG. 9 shows photographs of the axle bearing, and the inner ring and the outer ring of the axle bearing, before the heat-resistant rotation test. FIG. 10 shows the axle bearing in a high-temperature chamber after the heat-resistant rotation test. FIG. 11 shows photographs of the inner ring and the outer ring, when the axle bearing is disassembled after the heat-resistant rotation test.

It is found from FIG. 10 that the axle bearing formed from the SUS440C produces many abrasion powders, while the axle bearing formed from the embodiment sample 1 produces little abrasion powder. It is also found from FIGS. 9 and 11 that, although the inner ring and the outer ring formed from the SUS440C and the inner ring and the outer ring formed from the embodiment sample 1 are oxidized and darkened with loss of metallic color due to the heat-resistant rotation test, they are different in the defect caused by this test. Specifically, many small irregularities are produced on the raceway surfaces of the inner ring and the outer ring formed from the SUS440C, and the rolling width is wide. On the other hand, the raceway surfaces of the inner ring and the outer ring formed from the embodiment sample 1 have a few small irregularities, and the rolling width is not so wide (FIG. 11). It is also found that seizure is not produced on the inner ring and the outer ring formed from the embodiment sample 1 (FIG. 11).

Table 10 shows the result of the measurement of abrasion amount of the inner ring and the outer ring after the heat-resistant rotation test. It is found from Table 10 that the abrasion amount of the inner ring and the outer ring formed from the embodiment sample 1 is dramatically smaller than the abrasion amount of the inner ring and the outer ring formed from the SUS440C. It is understood from FIGS. 10 and 11 and Table 10 that the axle bearing formed from the embodiment sample 1 is difficult to be seized and worn at high temperature. It is supposed that the contact area increases with the temperature rise, so that the influence by the friction and abrasion increases. It can be understood from these results that the axle bearing formed from the embodiment sample 1 is excellent in abrasion property. It can also be understood that the defect is difficult to be produced on the raceway surface, because hardness can be maintained at high temperature.

The abrasion amount of the inner ring and the abrasion amount of the outer ring, formed from the material of the embodiment sample 1, due to the fatigue are considered to be the total abrasion amount of the axle bearing, and the life time of the axle bearing was calculated with the SUS440C being defined as a reference. With this calculation, it can be confirmed that the axle bearing whose inner ring and the outer ring were formed from the embodiment sample 1 took 8336 hours until the abrasion amount reached the amount equal to the abrasion amount of the axle bearing whose inner ring and the outer ring was formed from the SUS440C (Table 10). It is understood that the axle bearing formed from the embodiment sample 1 has extremely long life under high-temperature environment, and excellent heat resistance property.

TABLE 10

| | | Abrasion | Abrasion | |
|---|---|---|---|---|
| Material of inner | | amount of | amount of | |
| ring and outer ring | Test time | inner ring | outer ring | Life time |
| SUS440C | 100 hr | 711 μm | 780 μm | 100 hr |
| Embodiment sample 1 | 123 hr | 0 μm | 22 μm | 8336 hr |

### CONCLUSION

As is understood from the results of the evaluation, the embodiment sample 1 is totally different from a general bearing material such as SUS440C in property, and the mechanical property of the embodiment sample 1 is hardly changed even with the temperature rise. The axle bearing formed from the embodiment sample 1 is equal to the SUS440C in the rolling fatigue life test at room temperature, but it has very long life and exhibits excellent heat resistance property in the heat-resistant rotation test under high-temperature environment. Accordingly, the axle bearing formed from the embodiment sample 1 is well adapted for the usage requiring long life at high temperature.

Since the Ni₃(Si, Ti)-based intermetallic compound alloy has a non-magnetic property, the axle bearing formed from this intermetallic compound alloy is difficult to produce deposition of abrasion powders into the raceway ring, the deposition being caused by magnetization. Consequently, it has a property of suppressing acceleration of abrasion. This axle bearing is also well adapted to the usage (e.g., semiconductor manufacturing device) requiring non-magnetic property.

### EXPLANATION OF NUMERALS

1 Roll bearing (ball bearing)
1A Slide bearing
2 Inner ring
2A, 3A Raceway surface
2B Slide surface
3 Outer ring
4 Rolling element
5 Holder
10 Thrust rolling life testing machine
11 Drive shaft
12 Inner ring
13 Ball
14 Test piece
15 Bearing box

1. A high-temperature axle bearing made of an Ni₃(Si, Ti)-based intermetallic compound alloy, wherein the Ni₃(Si, Ti)-based intermetallic compound alloy contains from 25 to 500 ppm by weight of B with respect to a total weight of a composition of 100 at. % containing Ni as a major component, from 7.5 to 12.5 at. % of Si, from 4.5 to 10.5 at. % of Ti, from 0 to 3 at. % of Nb, and from 0 to 3 at. % of Cr, and has a Vickers hardness from 210 to 280 at 800° C.

2. The high-temperature axle bearing according to claim 1, wherein the Ni₃(Si, Ti)-based intermetallic compound alloy has a difference from 50 to 200 in Vickers hardness between room temperature and 800° C.

3. The high-temperature axle bearing according to claim 1, wherein the Ni₃(Si, Ti)-based intermetallic compound alloy contains from 25 to 100 ppm by weight of B with respect to the total weight of the composition of 100 at. % containing Ni as a major component, from 10.0 to 12.0 at. % of Si, from 5.5 to 9.5 at. % of Ti, from 1.5 to 2.5 at. % of Nb, and from 1.5 to 2.5 at. % of Cr.

4. The high-temperature axle bearing according to claim 1, wherein the Ni₃(Si, Ti)-based intermetallic compound alloy has a single-phase microstructure including an L1₂ phase, or a microstructure including an L1₂ phase and an Ni solid solution phase.

5. A high-temperature axle bearing comprising: an inner ring; an outer ring; and rolling elements that roll between the inner ring and the outer ring, wherein the rolling elements are made of a ceramic material, and at least one of the inner ring and the outer ring is made of an Ni₃(Si, Ti)-based intermetallic compound alloy containing from 25 to 500 ppm by weight of B with respect to a total weight of a composition of 100 at. % containing Ni as a major component, from 7.5 to 12.5 at. % of Si, from 4.5 to 10.5 at. % of Ti, from 0 to 3 at. % of Nb, and from 0 to 3 at. % of Cr, and has a Vickers hardness from 210 to 280 at 800° C.

6. The high-temperature axle bearing according to claim 5, wherein the rolling elements are made of silicon nitride.

7. A method of producing a high-temperature axle bearing, comprising the steps of:
heat-treating an ingot containing from 25 to 500 ppm by weight of B with respect to a total weight of a composition of 100 at. % containing Ni as a major component, from 7.5 to 12.5 at. % of Si, from 4.5 to 10.5 at. % of Ti, from 0 to 3 at. % of Nb, and from 0 to 3 at. % of Cr; and
forming an axle bearing from the heat-treated ingot, wherein
the step of heat-treating to the ingot is to form an ingot having a Vickers hardness from 210 to 280 at 800° C. by the heat treatment.

8. A method of producing a high-temperature axle bearing, comprising the steps of:
forming an axle bearing from an ingot containing from 25 to 500 ppm by weight of B with respect to a total weight of a composition of 100 at. % containing Ni as a major component, from 7.5 to 12.5 at. % of Si, from 4.5 to 10.5 at. % of Ti, from 0 to 3 at. % of Nb, and from 0 to 3 at. % of Cr; and
heat-treating the axle bearing formed from the ingot, wherein
the step of heat-treating the axle bearing is to form the axle bearing having a Vickers hardness from 210 to 280 at 800° C. by the heat treatment.
